(19) United States
(12) Patent Application Publication
(10) Pub. No.: US 2007/0165526 A1
(43) Pub. Date: Jul. 19, 2007

(54) Wireless QoS by hardware packet sizing, data rate modulation, and transmit power controlling based on the accumulated packet drop rate

(76) Inventor: Hyun Lee, Ladera Ranch, CA (US)

Correspondence Address: Hyun Lee, 21 Thalia St, Ladera Ranch, CA, 92694, US

(21) Appl. No.: 11/585,606

(22) Filed: Oct. 24, 2006

Related U.S. Application Data
(60) Provisional application No. 60/758,724, filed on Jan. 14, 2006.

(51) Int. Cl. H04L 12/26; H04Q 7/00

(52) U.S. Cl. 370/230; 370/332

(57) ABSTRACT

Two methods to improve the QoS. These methods can be applied individually or together. The first method is a packet sizing method, which is based on the Bit Error rate as well as the packet drop rate. The second method is a data transmit rate modulation method. The proposed methods in this invention, unlike the packet size reduction method that is in the WiMedia specification, enables the MAC to reduce and increase the packet size and the data transmit rate by working with the upper layer controller to maximize the data transfer rate, the transmitter power, and to minimize the packet drop rate.

### RELATED APPLICATIONS

The present application is a continuation application of United States provisional patent application, serial number US60/758,724, filed Jan. 14, 2006, for IMPROVING WIRELESS QOS BY HARDWARE PACKET SIZING, DATA RATE MODULATION, AND TRANSMIT POWER CONTROLLING BASED ON THE ACCUMULATED PACKET DROP RATE, by Hyun Lee, included by reference herein and for which benefit of the priority date is hereby claimed.

### FIELD OF THE INVENTION

The present invention generally relates to the fields of home and personal wireless networking and, more particularly, to Wireless SOHO Networks, Wireless Home Area Networks or Wireless Personal Area Networks that are based on various standard communication protocols.

### BACKGROUND OF THE INVENTION

In general, since the wired channel error rate is very low, the wired network QoS is the function of the data generation and delivery rate of the network system, and the packet error rate in the communication channel is not a primary factor. However, in a wireless network, due to the high channel error rate, the major reduction of the QoS of a system is due to the high packet drop (error) rate due to the channel noise and interferences. The UWB/WiMedia working group incorporated the Forward Error Correcting (FEC) methods into the standards to combat the wireless channel noise. However, the incorporated FEC only targets the Bit Error Rate (BER) less than 10E-5, which is not sufficient to support the real time operation that requires much lower BER.

For example, the data rate required for the High Definition TV (HDTV) is approximately 20 Mb/s. This HDTV data rate translates to 20 1 k-byte packets every 1 msec. Assuming the upper layer controller moves the HDTV of data once every 1 msec, the BER of 10E-5 causes 2 packets to drop every 1 msec. The effective transfer rate of a wireless network based on the WiMedia is given in Table 1 (100).

Table 1 (100) indicates that, although the WiMedia provides the data rate as high as 480 Mbps, the WiMedia standard can support the HDTV data rate only if the transfer distance is less than 4 meters assuming the bit error rate is negligible. However, with the WiMedia allowed bit error rate of 10E-5, the WiMedia standard would not be able to support the HDTV operation. Therefore, the overall UWB system needs to either increase the effective data rate or substantially reduce the BER to be able to provide the QoS that is acceptable the real time operation.

QoS of a wireless network depends on two parameters, the data throughput rate and the latency of data delivery. These two parameters are functions including three variables; the packet size, the data transfer rate, and the packet loss rate. These three variables are inter related to each other by a set of measurable and controllable parameters such as the signal to noise ratio, the coding rate, the efficiency of antennas, the receiver sensitivity which is directly related to the transmit power level and distance, etc. Among these parameter, hardware controller can control the packet size, data transfer rate, and the transmit power.

The decision making process on the packet size and the rate needs to include the packet overhead.

The packet overhead for each packet consists of the Physical Layer Convergence Procedure (PLCP) preamble, PLCP, and Inter Frame Space (IFS). The preamble time is either 9.375 usec for the standard preamble, and 4.6875 usec for the burst preamble. The IFS is 2 usec for the Bust packet IFS (MIFS) and 10 usec for the Single packet IFS (SIFS), the PLCP time is 2.1875 usec. Therefore, the packet transfer overheads are

Single packet overhead (Soh)=9.375 usec+10 usec+2.1875 usec=21.5625 usec, and

Burst packet overhead (Boh)=4.6875 usec+2 usec+2.1875 usec=8.875 usec.

The overall effective data transfer rate is

Single packet transfer data rate (SPR)=(Ps*(1−PER))/(Soh+Pt), where
Ps is the payload size in bytes, Pt is the payload transfer time, and PER is the Packet Error Rate, where
PER=BER*8*Ps, and
Pt=(Ps*8)/Pr,
   where Pr is the payload data transferrate.

Therefore,

SPR=(Ps−8*BER*Ps2)*Pr/(Pr*Soh+8*Ps),
where BER is a function of Pr, and
Pr is a function of the Rx sensitivity (Prx).

The change of data rate is simply δSPR/δPs or

$$( δ SPR / δ BER ) * ( δ BER / δ Pr ) * ( δ Pr / δ Ps )$$

$$δ SPR / δ Ps = ( 1 - 8 * BER * Ps ) * Pr 2 * Soh / ( Pr * Soh + 8 * Ps ) 2$$

$$also$$

$$\begin{matrix}δ SPR / δ Ps = ( δ SPR / δ BER ) * ( δ BER / δ Pr ) * ( δ Pr / δ Ps ) \\ = ( - 8 * Ps 2 * Pr / ( Pr * Soh + 8 * Ps ) ) * ( δ BER / δ Pr ) * ( δ Pr / δ Ps ) .\end{matrix}$$

Thus, the change of the single packet transfer data rate is a function of 1/Ps, and a function the δBER/δPr.

The Pr is and the Prx has the bijection relationship for the given distance, the noise level, transmits power, and other semi-static variables such as the antenna efficiency. Thus, the term δPr/δPs, without loosing the generality, can be replaced with a constant.

Therefore, with a given sets of Ps and Pr, the QoS Enhancer makes decision on whether to change the Pr, Ps or the both.

The data rate, Pr, has quantized values for the WiMedia, and the values are 53.5, 80, 106.7, 160, 200, 320, 400, and 480.

The Transmit power at the antenna is

TxPower=EIRP*BW*Tx ratio=41.3 dBm/MHz*528 MHz*Tx ratio=−10.3 dBm

Table 2 (200) shows the Rx sensitivity or the likely signal energy level at the receiver end when the original transmit power is −10.3 dBm. Table 3 (300) shows the noise power at different data rate. Since the signal energy needs to overcome the noise power, the effective signal strength at the receiver ends become Eb/No, or ‘Rx_sensitivity−Total Noise Power’. In general this is the signal to noise margin for the wireless network. However, in reality, the physical inefficiency of the receiver requires additional signal energy, which is defined as the Implementation Loss. In addition to these numbers, network design needs a safety margin, i.e. Link-Margin (LM), which is not a number that is associated with any physical environment, but a number that ensures the proper operation of the network under unexpected cases.

The Table 4 (400) shows the budget for the Eb/No+LM. This table shows that if the network system designer allots a bigger number for the LM, the Eb/No becomes smaller, and the designer has to assume the higher BER. The WiMedia standard allots 3 bB for the LM.

The UWB working groups, WiMedia Alliance and 802.15 developed the UWB communication standards based on the Multi-Band OFDM. These standards define the target data transfer Bit Error Rate (BER) as 10e-5, which constitutes 8% of packet drop rate with the average packet size of 1024 bytes. However, this bit error rate is unacceptable for the real time application where the QoS is measured not only in terms of the data transfer rate but also in terms of the delivery latency and the data bandwidth fluctuation. Unlike standard USB, which does not check the integrity of the isochronous packet delivered, the wireless USB based on the WiMedia standard checks the integrity of the UWB packet payload, which is the WUSB packet. If the FCS of the WUSB packet fails, the WUSB MAC rejects the packet. Therefore, the bit error rate of 10e-5 causes significant deficiency in supporting any real time operation since it reduces the QoS in terms of the substantial increase of the delivery time of packets due to two facts.

The first is the case when the data transfer is done with the isochronous burst mode operation, which transfers multiple packets in one transaction. In this case, the USB software cannot deliver those packets received after the packet with error (i.e. dropped packet) since the USB software has to deliver the entire packets in the order it received. Therefore, losing a single packet impacts the delivery time of a number of packets in the burst mode transfer. The QoS degradation on the overall system in this case is far more severe than single packet transfer case since the increase in the delivery time of multiple packets may cause the operation of a real time system to be completely out of synchronization.

The second, the case when the data transfer is done with single packets transfer in one transaction. In this case, the overall data rate suffers much higher rate than 8% packet drop (error) rate since each transaction requires significant packet overhead. This overhead does not include the time that generally needs to set up each transaction prior to the actual occurrence of packet transfer. The effective data transfer rate drops by 8.2% with 1024-byte payload, but the effective rate drops by 24.6% with 3076-byte payload.

The WiMedia standard provide a remedy to this problem by suggesting that the MAC to reduce the packet payload size to decrease the packet drop rate, and thus increase the effective data transfer rate. However, this suggestion presents two problems that were previously discussed in this application, for example, “WiMedia/MBOA—Wireless Medium Access Control (MAC) Specification and Wireless Universal Serial Bus” (WUSB)—Specification Revision 1.0.

First, the MAC to choose the proper packet size based on the average/accumulated packet drop rate, it increases the packet delivery time.

Second, since the wireless communication environment can vary dynamically, the delayed decision made by the upper layer controller may not be adequate for the real time operation

It is therefore an object of the invention to present a process that improves the QoS in terms of the Bit Error Rate by the factor of 1E3.

It is another object of the invention to demonstrate that reduction of the PHY data rate may result in the higher data transfer rate.

It is another object of the invention to demonstrate that the data transfer rate can be best optimized by varying the PHY data rate and the packet size together

It is another object of the invention to demonstrate that a look-up table, which shows the packet size and PHY data rate vs. change of the average data transfer rate (700), can be constructed, based on a simple mathematical model,

It is another object of the invention to demonstrate that the look-up table can be used by the wireless network to achieve the optimum or near optimum data transfer rate (700,710,720).

### SUMMARY OF THE INVENTION

In accordance with the present invention, there is provided two methods to improve the QoS. These methods can be applied individually or together. The first method is a packet sizing method, which is based on the Bit Error rate as well as the packet drop rate. The second method is a data transmit rate modulation method. The proposed methods in this invention, unlike the packet size reduction method that is in the WiMedia specification, enables the MAC to reduce and increase the packet size and the data transmit rate by working with the upper layer controller to maximize the data transfer rate, the transmitter power, and to minimize the packet drop rate.

The uppler layer hardware controller may instruct MAC to reduce or increase the transfer packet size to achieve the optimum packet size that is not larger than the size the upper layer controller instructed. This is to avoid any local buffer overflow issue.

The hardware also controller may reduce or increase the data transmit rate to achieve the optimum data rate that is not faster than the rate the upper layer controller instructed. This is to avoid any system level throughput rate issue. Therefore, this invention suggests setting the upper bounds of the packet size and the data rate to be the values set according to the system configuration to allow the upper layer controller to search for the maximum effective data rate without interfering with the system level operation.

This invention comprises of three sections. The first section contains registers that hold the control information. The second section collects the statistical QoS information for the next operation. The third section works with the UWB MAC to control the PHY for the optimum data rate based on the mathematical (algorithm).

The information in the registers defines the working boundaries of the QoS operation. For example, the third section will not become active if the bit error rate detected by the second section does not exceeds the acceptable BER that is stored in the registers in the first section. The third section may override the packet sizes and/or the data rates that were set according to the system configuration, but it would never increase the packet size and the data transfer rate larger than the instructed sizes and rates that are defined in the first section.

The second section monitors the BER along with the payload size of each received packets to decide the Dynamic BER (DBER).

This section accumulates the DBER information over a number of packets, and alerts the third section of the excessive BER if the accumulated average of the DBER is greater than the acceptable BER in the registers. The DBER accumulation duration is defined in the first section registers.

The third section, when it receives the DBER alert, reads the DBER status register in the first section, and selects the optimum packet size to minimize the BER, and also to maximize the effective data transfer rate. This section also investigate the option to reduce the PSDU bit rate to increase the Rx sensitivity level so to increase the Eb/No ratio, and to improve the BER.

For example, from Table 4 (400), by reducing the PSDU rate from 200 Mbps to 160 Mbps, the noise power reduces by 1 dB and the coding changes from QPSK-5/8 to QPSK-1/2. This results in the BER improvement of 2E3 (from 4E-5 to 2E-8 in graphs FIG. 5 (500) and FIG. 6 (600)) with the AWGN mode if the Eb/No for the 200 Mbps was 5 dB, and the packet error rate from 33% to 0.02% with 1024 bytes PSDU size. Therefore, the effective data rate increases from 132 Mbps to 160 Mpbs. This effective data transfer rate increase is much significant than the packet sizing.

However, sometimes the packet sizing is the only option to achieve the optimum effective data transfer rate if the allotted data transfer time is short than the next slower quantized rate such as reducing the PSDU bit rate from 200 Mpbs to 160 Mbps increase the transfer time from 62.5 usec to 72.7 usec.

### BRIEF DESCRIPTION OF THE DRAWINGS

A complete understanding of the present invention may be obtained by reference to the accompanying drawings, when considered in conjunction with the subsequent, detailed description, in which:

FIG. 1 is a FIG. 1 is a table that shows the maximum allowed bandwidth per device. the wimeida protocol preserves the fairness policy among the network devices by restricting the maximum bandwidth that can occupied by a device in the network;

FIG. 2 is a FIG. 2 shows the required receiver rx sensitivity to be able to successfully receive data that is transmitted with the transmit power of −10.3 db;

FIG. 3 is a FIG. 3 shows the noise power that is associated with the payload data rate;

FIG. 4 is a FIG. 4 shows the noise budget plus the lm (line margin) for various payload data rate; FIG. 5 is a FIG. 5 is the upper bound of the bit error rate (ber) for 5/8 encoded signal with time spreading of 2; FIG. 6 is a FIG. 6 is the upper bound of the bit error rate (ber) of signal with the code rate of 1/2, and time spreading of 2; FIG. 7 is a FIG. 7-a, 7-b and 7-c are the performance table with each cell holds the relative performance improvement when the data transmit rate and/or the packet size are changed; and

FIG. 8 is a FIG. 8 is an example of a methodical way of making dynamic error rate forecasts, and selecting the right qos improving procedure.

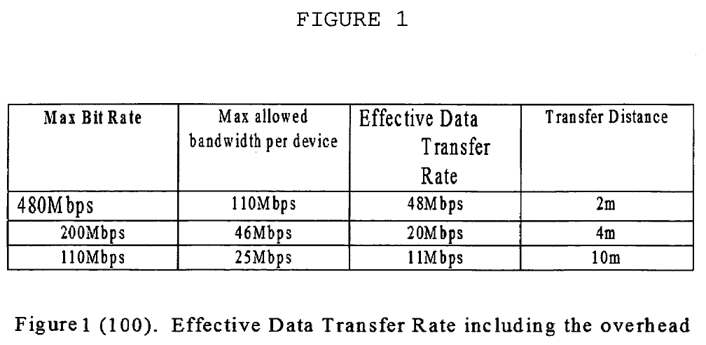

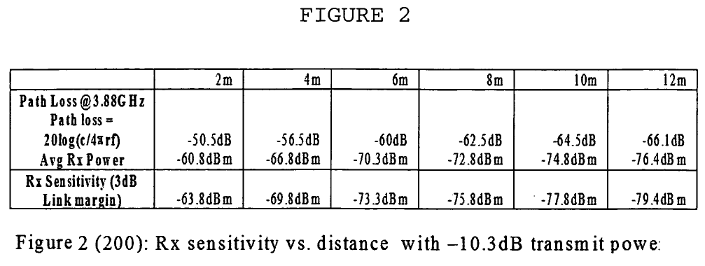

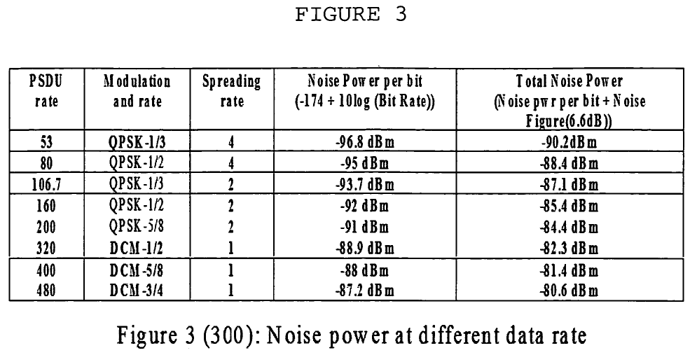

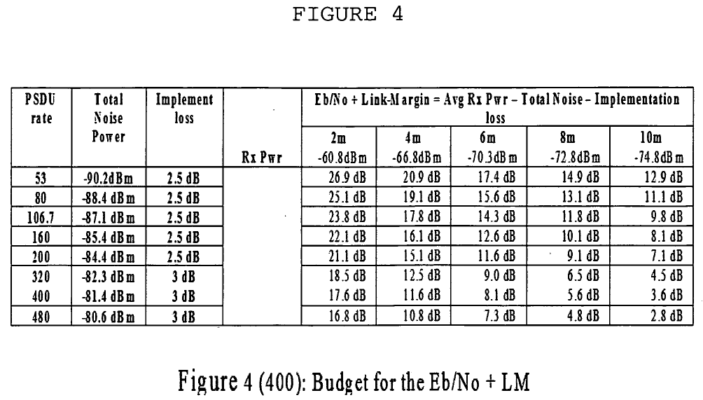

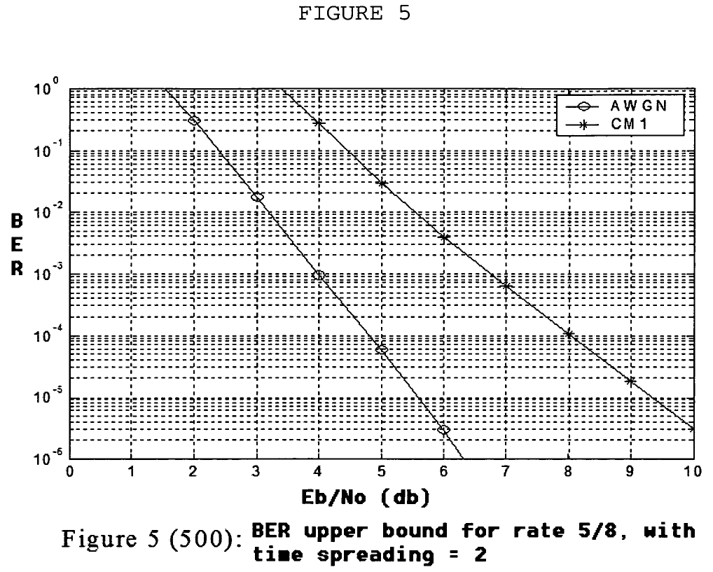

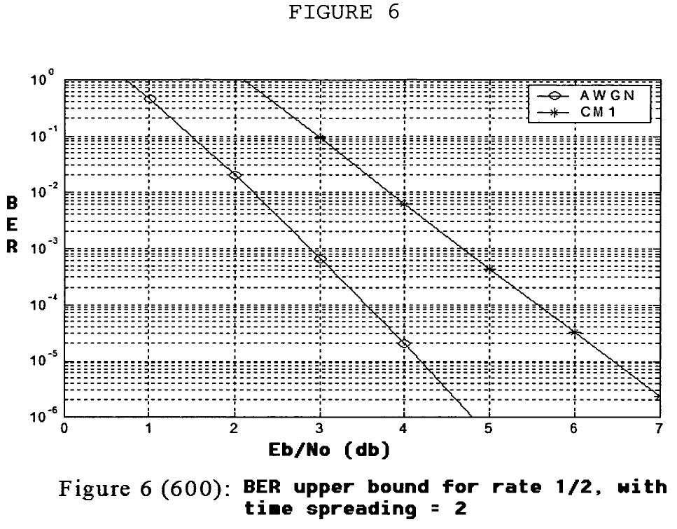

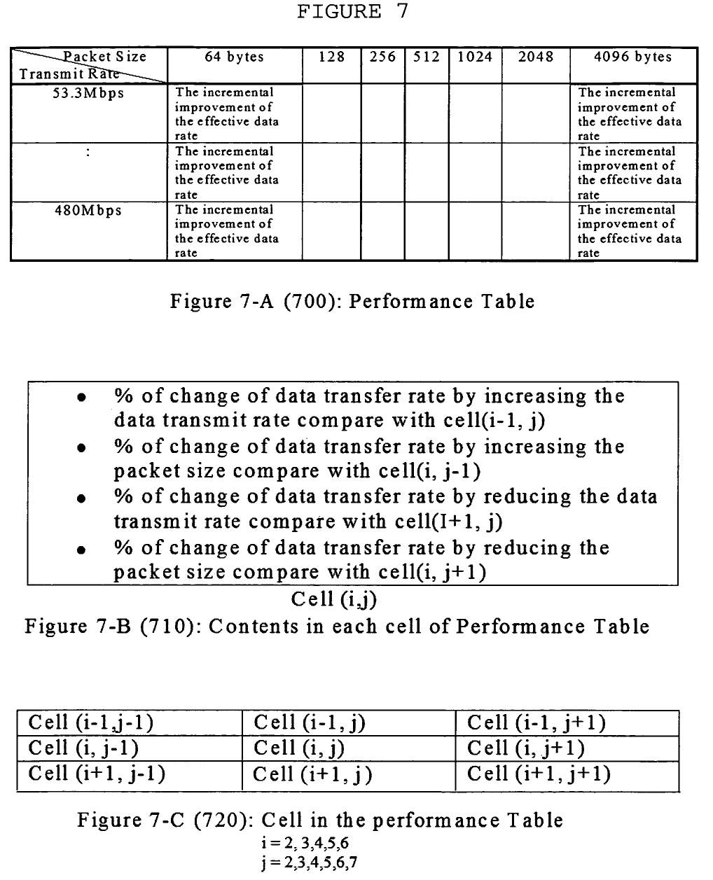

For purposes of clarity and brevity, like elements and components will bear the same designations and numbering throughout the Figures.

### DESCRIPTION OF THE PREFERRED EMBODIMENT

This description is an example of how to utilize the packet sizing and the data transmit rate modulation methods to improve the QoS of wireless communication. Although this invention applies to any wireless network, the WiMedia protocol is chosen for this example.

This example requires a performance table 700 that indicates the incremental improvement of the QoS. The table format is shown at below in FIG. 7.

Each cell (710) in the above table contains 4 values that shows the % change of effective data rate from the adjacent cell. For example (720), the cell corresponds to the 200 Mbps PSDU rate and 1024 bytes PSDU Size contains two numbers. The first number is the change of effective data rate by increasing the PSDU size from 512 to 1024 bytes. The second number indicates the % of improvement when the PSDU rate increases from 160 Mbps to 200 Mbps including the effect of the increase of the Noise Power due to the increase of the PSDU rate.

Example of QoS Improving Procedure:

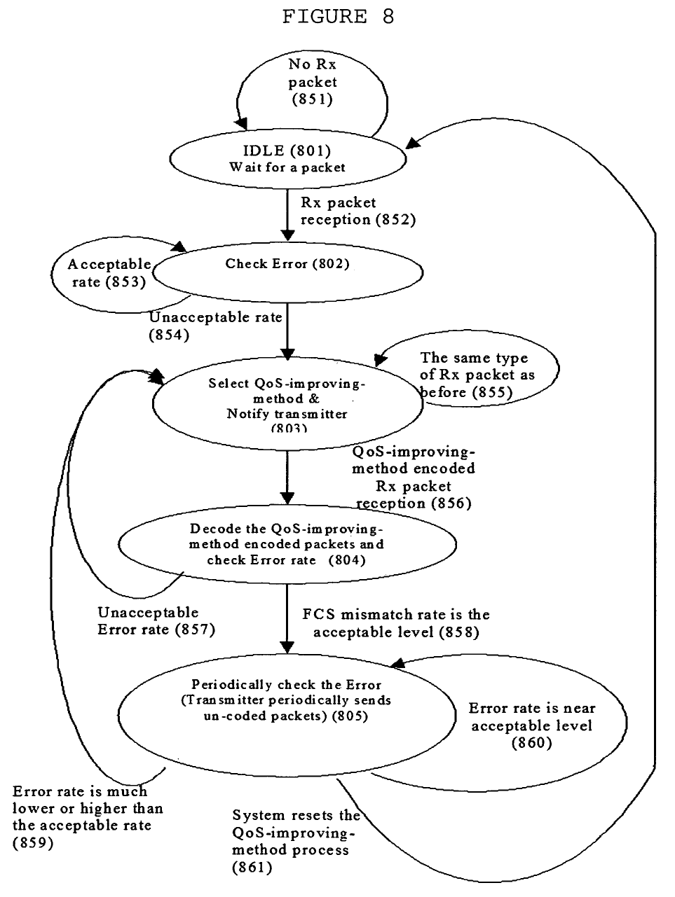

FIG. 8 (800) shows an example of a methodical way of making dynamic error rate forecasts, and selecting the right QoS improving procedure.

When a wireless transfer starts (852), the receiving MAC starts to accumulate two events: the average received packet size and the number of errors.

If the error rate (802) is acceptable (853) for the given application, no action is taken. The acceptable error rate is based on the error free packet transfer rate for a given application. If the error rate is unacceptably high (854), the receiver starts walk on the Performance Table 700 that is described previously. The receiver first move to lower PSDU size (the next cell on left), than the lower PSDU rate (the next cell one above) until it lands on the cell that can reduce the error rate at the same time to support the desired data rate to support the application. Once the receiver makes the decision on the PSDU size and the PSDU rate or the optimum QoS, it notifies the transmitter (of the specific device) using the Application-specific command frame (803). The transmitter transmits data according to the receiver's request. The transmitter also indicates that the packet is a QoS-improving-method-encoded packet by setting the appropriate bit in the Application-specific command frame.

After the first QoS-improving-method encoded packet is received (856), the receiver resets the average received packet size and the error rate. The receiver repeats this process until the FCS mismatch rate is acceptable for the given application (857).

In general, since the receiver should be able to choose the right PSUD size and the rate based on the prior events (the average error rate for the average packet size), the receiver only needs to execute the QoS-improving-method selecting process once or twice per device.

If the error rate is much better than the acceptable rate (859), the receiver may send a request to the transmitter to transfer the original PSDU size and rate packets.

If the error rate goes up at this time, the receiver sends a new QoS-improving-method to reduce the error rate (859,803). The transmitter periodically transmits special packets to check the level of the wireless channel error injection rate (805). If the receiver determines the error rate is blow the acceptable rate, the receiver requests the transmitter to send un-encoded packets (859).

Since other modifications and changes varied to fit particular operating requirements and environments will be apparent to those skilled in the art, the invention is not considered limited to the example chosen for purposes of disclosure, and covers all changes and modifications which do not constitute departures from the true spirit and scope of this invention.

Having thus described the invention, what is desired to be protected by Letters Patent is presented in the subsequently appended claims.

What is claimed is:

1. An improving wireless qos by hardware packet sizing, data rate modulation, and transmit power controlling based on the accumulated packet drop rate for improving wireless qos by hardware packet sizing, data rate modulation, and transmit power controlling to support multiple simulatenous high data rate communication including streaming video, such as hdtv, comprising:
means for during the idle period, a device performs the range check, and program the mac with the expected bit error rate of the received signals from each device in the wireless network under average white gaussian noise (awgn) environment;
means for collecting the fcs mismatch rate, the average packet size, and/or the bit error rate (ber) under the current environmental condition where the sources of the channel noise could be the interference from other uwb signals or from the narrowband/broadband signals;
means for the upper layer (transport, network) layer selecting a qos improving method using the performance table (700), and instructing a designated transmitter to encode the packet with the qos improving method that would specify the packet size, the transmit power level, the data rate (or code rate), and/or error-correcting-code;
means for the receiver checking the bit error rate of the packet that is sent by the dedicated device transmitted with the qos improvement method;
means for indicating that, once the error rate is acceptable with the current qos improving method, the upper layer monitoring the channel noise level by instructing a device to periodically transmitting specific packets;
means for recognizing the start of type of wireless packet transfer;
means for indicating that the qos improvement process does not need to continue if the error rate is acceptable for the application;
means for indicating that, if the fcs mismatch rate is unacceptably high, the receiver starts walk on the performance table (700) for the purpose of finding the optimum data rate and the packet size as;
means for tuning the qos improving process for a particular application;
means for indicating that, after a qos improvement method as been selected, the software instructs the devices to encode the transmit packets with the select qos improving method for the particular application;
means for indicating that the increasing error rate during the normal operation would cause the software to restart the qos improving process until the fcs mismatch rate becomes acceptable for the given application;
means for indicating the selected qos improving method has improved the error rate to the acceptable level for the application;
means for indicating that the reduction in the channel noise during the normal operation allows the software to choose a less costly qos improvement method, and further improve the network throughput rate;
means for indicating that the error rate is at the level where the network can support the application;
means for indicating that either the system is reset or the application is completed the qos improvement process;
means for a performance table with each cell in the table indicating the % change of effective data rate from the adjacent cell by altering the transmit data rate and the packet payload (psdu) size;
means for holding the relative change of the effective data transfer rate as incremental change of the phy data rate and the packet size; and
means for representing the table organization where the row values are the phy data rate, and the column values are the packet sizes.

2. The improving wireless qos by hardware packet sizing, data rate modulation, and transmit power controlling based on the accumulated packet drop rate in accordance with claim 1, wherein said means for during the idle period, a device performs the range check, and program the mac with the expected bit error rate of the received signals from each device in the wireless network under average white gaussian noise (awgn) environment comprises a state idle.

3. The improving wireless qos by hardware packet sizing, data rate modulation, and transmit power controlling based on the accumulated packet drop rate in accordance with claim 1, wherein said means for collecting the fcs mismatch rate, the average packet size, and/or the bit error rate (ber) under the current environmental condition where the sources of the channel noise could be the interference from other uwb signals or from the narrowband/broadband signals comprises a state check error.

4. The improving wireless qos by hardware packet sizing, data rate modulation, and transmit power controlling based on the accumulated packet drop rate in accordance with claim 1, wherein said means for the upper layer (transport, network) layer selecting a qos improving method using the performance table (700), and instructing a designated transmitter to encode the packet with the qos improving method that would specify the packet size, the transmit power level, the data rate (or code rate), and/or error-correcting-code comprises a state select qos improving method & notify transmitter.

5. The improving wireless qos by hardware packet sizing, data rate modulation, and transmit power controlling based on the accumulated packet drop rate in accordance with claim 1, wherein said means for the receiver checking the bit error rate of the packet that is sent by the dedicated device transmitted with the qos improvement method comprises a state, decode the qos improving method encoded packet & check error rate.

6. The improving wireless qos by hardware packet sizing, data rate modulation, and transmit power controlling based on the accumulated packet drop rate in accordance with claim 1, wherein said means for indicating that, once the error rate is acceptable with the current qos improving method, the upper layer monitoring the channel noise level by instructing a device to periodically transmitting specific packets comprises a state, periodically check the error.

7. The improving wireless qos by hardware packet sizing, data rate modulation, and transmit power controlling based on the accumulated packet drop rate in accordance with claim 1, wherein said means for recognizing the start of type of wireless packet transfer comprises an event, rx packet reception.

8. The improving wireless qos by hardware packet sizing, data rate modulation, and transmit power controlling based on the accumulated packet drop rate in accordance with claim 1, wherein said means for indicating that the qos improvement process does not need to continue if the error rate is acceptable for the application comprises a decision point acceptable rte.

9. The improving wireless qos by hardware packet sizing, data rate modulation, and transmit power controlling based on the accumulated packet drop rate in accordance with claim 1, wherein said means for indicating that, if the fcs mismatch rate is unacceptably high, the receiver starts walk on the performance table (700) for the purpose of finding the optimum data rate and the packet size as comprises a decision point, unacceptable rate.

10. The improving wireless qos by hardware packet sizing, data rate modulation, and transmit power controlling based on the accumulated packet drop rate in accordance with claim 1, wherein said means for tuning the qos improving process for a particular application comprises an action, continue checking the same type of rx packet.

11. The improving wireless qos by hardware packet sizing, data rate modulation, and transmit power controlling based on the accumulated packet drop rate in accordance with claim 1, wherein said means for indicating that, after a qos improvement method as been selected, the software instructs the devices to encode the transmit packets with the select qos improving method for the particular application comprises an action, qos improving encode completed.

12. The improving wireless qos by hardware packet sizing, data rate modulation, and transmit power controlling based on the accumulated packet drop rate in accordance with claim 1, wherein said means for indicating that the increasing error rate during the normal operation would cause the software to restart the qos improving process until the fcs mismatch rate becomes acceptable for the given application comprises a decision point, unacceptable error rate.

13. The improving wireless qos by hardware packet sizing, data rate modulation, and transmit power controlling based on the accumulated packet drop rate in accordance with claim 1, wherein said means for indicating the selected qos improving method has improved the error rate to the acceptable level for the application comprises a decision point, fcs mismatch rate acceptable.

14. The improving wireless qos by hardware packet sizing, data rate modulation, and transmit power controlling based on the accumulated packet drop rate in accordance with claim 1, wherein said means for indicating that the reduction in the channel noise during the normal operation allows the software to choose a less costly qos improvement method, and further improve the network throughput rate comprises a decision point, much lower error rate.

15. The improving wireless qos by hardware packet sizing, data rate modulation, and transmit power controlling based on the accumulated packet drop rate in accordance with claim 1, wherein said means for indicating that the error rate is at the level where the network can support the application comprises an observation, error rate acceptable.

16. The improving wireless qos by hardware packet sizing, data rate modulation, and transmit power controlling based on the accumulated packet drop rate in accordance with claim 1, wherein said means for indicating that either the system is reset or the application is completed the qos improvement process comprises a done, reset system reset.

17. The improving wireless qos by hardware packet sizing, data rate modulation, and transmit power controlling based on the accumulated packet drop rate in accordance with claim 1, wherein said means for a performance table with each cell in the table indicating the % change of effective data rate from the adjacent cell by altering the transmit data rate and the packet payload (psdu) size comprises a table, performance table.

18. The improving wireless qos by hardware packet sizing, data rate modulation, and transmit power controlling based on the accumulated packet drop rate in accordance with claim 1, wherein said means for holding the relative change of the effective data transfer rate as incremental change of the phy data rate and the packet size comprises a data transfer rate, contents of performance table.

19. The improving wireless qos by hardware packet sizing, data rate modulation, and transmit power controlling based on the accumulated packet drop rate in accordance with claim 1, wherein said means for representing the table organization where he row values are the phy data rate, and the column values are the packet sizes comprises a table organization, cells in the table.

20. An improving wireless qos by hardware packet sizing, data rate modulation, and transmit power controlling based on the accumulated packet drop rate for improving wireless qos by hardware packet sizing, data rate modulation, and transmit power controlling to support multiple simulatenous high data rate communication including streaming video, such as hdtv, comprising:
a state idle, for during the idle period, a device performs the range check, and program the mac with the expected bit error rate of the received signals from each device in the wireless network under average white gaussian noise (awgn) environment;
a state check error, for collecting the fcs mismatch rate, the average packet size, and/or the bit error rate (ber) under the current environmental condition where the sources of the channel noise could be the interference from other uwb signals or from the narrowband/broadband signals;
a state select qos improving method & notify transmitter, for the upper layer (transport, network) layer selecting a qos improving method using the performance table (700), and instructing a designated transmitter to encode the packet with the qos improving method that would specify the packet size, the transmit power level, the data rate (or code rate), and/or error-correcting-code;
a state, decode the qos improving method encoded packet & check error rate, for the receiver checking the bit error rate of the packet that is sent by the dedicated device transmitted with the qos improvement method;
a state, periodically check the error, for indicating that, once the error rate is acceptable with the current qos improving method, the upper layer monitoring the channel noise level by instructing a device to periodically transmitting specific packets;
an event, rx packet reception, for recognizing the start of type of wireless packet transfer;
a decision point acceptable rte, for indicating that the qos improvement process does not need to continue if the error rate is acceptable for the application;
a decision point, unacceptable rate, for indicating that, if the fcs mismatch rate is unacceptably high, the receiver starts walk on the performance table (700) for the purpose of finding the optimum data rate and the packet size as;
an action, continue checking the same type of rx packet, for tuning the qos improving process for a particular application;
an action, qos improving encode completed, for indicating that, after a qos improvement method as been selected, the software instructs the devices to encode the transmit packets with the select qos improving method for the particular application;
a decision point, unacceptable error rate, for indicating that the increasing error rate during the normal operation would cause the software to restart the qos improving process until the fcs mismatch rate becomes acceptable for the given application;
a decision point, fcs mismatch rate acceptable, for indicating the selected qos improving method has improved the error rate to the acceptable level for the application;
a decision point, much lower error rate, for indicating that the reduction in the channel noise during the normal operation allows the software to choose a less costly qos improvement method, and further improve the network throughput rate;
an observation, error rate acceptable, for indicating that the error rate is at the level where the network can support the application;
a done, reset system reset, for indicating that either the system is reset or the application is completed the qos improvement process;
a table, performance table, for a performance table with each cell in the table indicating the % change of effective data rate from the adjacent cell by altering the transmit data rate and the packet payload (psdu) size;
a data transfer rate, contents of performance table, for holding the relative change of the effective data transfer rate as incremental change of the phy data rate and the packet size; and
a table organization, cells in the table, for representing the table organization where he row values are the phy data rate, and the column values are the packet sizes.
